(19) United States
(12) Patent Application Publication
(10) Pub. No.: US 2015/0124452 A1
(43) Pub. Date: May 7, 2015

(54) System and Method for an Adjustable Optics Assembly

(71) Applicant: 4S INDUSTRIES, INC. D/B/A/ BULLDOG-LIGHTING, INC., San Carlos, CA (US)

(72) Inventors: Lisa Sievers, San Carlos, CA (US); Dylan James Sievers, San Carlos, CA (US)

(73) Assignee: 4S INDUSTRIES, INC. D/B/A/ BULLDOG-LIGHTING, INC., San Carlos, CA (US)

(21) Appl. No.: 14/530,643

(22) Filed: Oct. 31, 2014

Related U.S. Application Data
(60) Provisional application No. 61/899,052, filed on Nov. 1, 2013.

(51) Int. Cl. F21V 19/00; F21V 21/14

(52) U.S. Cl. CPC F21V 19/004; F21V 21/14
USPC 362/249.03; 362/418

(57) ABSTRACT

An optics system for controlling the projection of LEDs using removable and adjustable inserts. The optics system includes, for example, a receptacle apparatus, a receptacle bowl and a rear entry insert that contains one or more LEDs of any wavelength. The receptacle apparatus contains a top surface; the receptacle bowl can be configured in multiple ways to control the projection of light from the insert. The insert snaps into the rear of the receptacle apparatus, and has a ridge that snaps into a groove on the receptacle apparatus. The removable inserts and the receptacle bowl adjust the projection of the light that initiates with the LED.

### CROSS REFERENCE TO RELATED APPLICATIONS

This application claims priority to U.S. Provisional No. 61/899,052 entitled “System and Method for a Reflector Lens Assembly” filed on Nov. 1, 2013 to Sievers, et al., the contents of which is hereby incorporated by reference in its entirety.

### BACKGROUND OF THE INVENTION

1. Field of the Invention

This invention relates generally to the field of optics using light emitting diodes.

2. Description of Related Art

A light emitting diode (hereinafter referred to as “LED”) is a semiconductor light source. Early LEDs emitted low intensity visible red light, which were only suitable for use as indicators, as the light output was insufficient to illuminate an area. Other low intensity colors became widely available and appeared in appliances and equipment. As LED materials technology grew more advanced, light output rose. First, a high brightness blue LED was developed in the 1990s and became widely available by the end of the decade. Later, a high-power white-light LED was developed, which along with high brightness blue, could be used for illumination.

LEDs are being used with increasing frequency in automotive lamps, medical devices, scientific instrumentation, and consumer electronics. LEDs are not only used for illumination and imaging but for communications, indicators and signaling also. One skilled in the art would know that LEDs are a rapidly growing industry and that their uses are expanding as technology expands and that to list all of their uses would be a never-ending process. Thus, LEDs are utilized in a wide spectrum of fields and services because they offer very long service life, extreme vibration resistance and can permit considerably shallower packaging compared to most light assemblies. Each of these fields can use the LEDs singularly and in plurality. Accordingly, a plurality of LEDs may be used in after-market vehicle light housing, also known as vehicle accessory lighting. For any vehicles this lighting can be mounted to off road trucks, four-wheelers, racing vehicles, farm equipment, boats and other recreational vehicles. Light housing typically use one or more rows of LEDs of a single color. To achieve light housing of multiple colors, many of the industries currently use one of three methods: (1) a colored lens over a string or combination of white LEDs; (2) a clear lens over a string or combination of colored LEDs; or (3) a colored lens over a string or combination of colored LEDs. Of these methods, only the clear lens over colored LEDs allows for multi-color customization to the extent that each LED can be a different color. Each color of LED coincides with a different wavelength of light, which include the infrared wavelength and the ultraviolet wavelengths. One skilled in the art recognizes that there is no specific range of wavelength that is limited in the use of LEDs.

LEDs output different intensities of light depending on their wavelengths, so colored LEDs output less light than does white LEDs. An amber LED can emit light in the range of 80-95 lumens per three watt LED. By comparison, a white LED of the same wattage emits at can currently emit up to four times that intensity. Additionally, colored LEDs are available in a limited number of colors, namely red, blue, green, amber and yellow.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 6,986,593, Rhoades et al., and U.S. Pat. No. 7,114,832, Holder, et al., describe an apparatus comprising an LED light source, a reflector and a lens, wherein the lens is suspended in front of the package lens by several alternative means.

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), Applicant(s) will amend the specification to expressly recite the essential material that is incorporated by reference as allowed by the applicable rules.

### BRIEF SUMMARY OF THE INVENTION

Particular embodiments may comprise one or more of the following features of the optics system. The embodiments can include a polymeric material receptacle apparatus comprising a receptacle bowl; and a removable insert located at a rear of the receptacle apparatus, the removable insert configured to be deterred from movement by contact between an insert body and the rear of the receptacle apparatus and the receptacle apparatus comprises a top surface and the rear of the receptacle apparatus comprises and inside groove and the insert comprises an outer ridge configured to snap into the groove at the rear of the receptacle apparatus. The receptacle apparatus comprises a post. The outer ridge of the insert comprises a lope from 0 to 65 degrees, wherein the outer ridge extends outward from the insert. The receptacle bowl comprises a parabolic shape having a radius that increases in distance from rear to front. Another embodiment includes a plurality of polymeric material receptacle apparatus comprising receptacle bowls and a plurality of removable inserts located at a rear of the receptacle apparatus, the removable inserts configured to be deterred from movement by contact between an insert body and the rear of the receptacle apparatus and the receptacle apparatus comprises a top surface and the rear of the receptacle apparatus comprises an inside groove and the insert comprises an inside groove and the insert comprises an outer ridge configured to snap into the groove at the rear of the receptacle apparatus, wherein each insert contains an LED. The optics system's plurality of receptacle apparatus are arranged in a circle, a star shaped, or a square pattern. The receptacle apparatus has a top surface that is clear, frosted, or colored. The receptacle apparatus contains a post that is configured to couple the apparatus receptacles to a mount. The material for the inside of the receptacle apparatus and the receptacle bowl is a reflective polymeric material and coating. The reflective polymeric material and coated receptacle bowl comprises a parabolic shape with a radius increasing from rear to front. Particular embodiments of the invention can also feature an optics system comprising a glass or glass composite receptacle apparatus comprising receptacle bowls; and a plurality a plurality of removable inserts located at a rear of the receptacle apparatus, the removable inserts configured to be deterred from movement by contact between an insert body and the rear of the receptacle apparatus and the receptacle apparatus comprises a top surface and the rear of the receptacle apparatus comprises an inside groove and the insert comprises an outer ridge configured to snap into the groove at the rear of the receptacle apparatus, wherein each insert contains one or multiple LEDs and the inserts, receptacle bowls and receptacle apparatus are all adjustable. The features include an insert lens where each lens is clear, frosted or colored and each LED inside of the insert emits a wavelength of light. The outer ridge of the insert contains a slop from 0 to 65 degrees. These inserts are adjustable by changing the insert ridge and each insert is shaped both inside and out, and the inside shape is uncorrelated to the outside shape. The insert's LED light projection is controlled by adjusting the design of both or either of the insert and the receptacle bowl. Each insert can contain zero to one brims and each insert contains a bottom that is attached to both the LED and the insert body.

One embodiment of the present invention provides, among other things, a system comprising a reflector apparatus and an LED insert, wherein the insert is snapped into the reflector apparatus from the rear and remains in place. The insert, which may be comprised of a polycarbonate or other polymeric material or glass and composites especially optically efficient material, has been molded such that along its outside circumference, a ridge is formed. In each embodiment of the ridge, the ridge is formed and shaped in a manner that allows the insert to be placed so that the insert can face any direction within the reflector apparatus. One skilled in the art can correlate the degree of change in ridge to correspond to the direction of the light output from the LED in the insert. The reflector apparatus, which may also be comprised of a polycarbonate or other polymeric material, has been injection molded such that along the inside circumference of each bowl, a corresponding groove is formed. When an insert is slipped into the opening at the base of one of the reflector bowls and pushed through, the ridge snaps into the groove of the reflector bowl and remains attached to the reflector apparatus.

One implementation of the present invention includes two reflector options, both having the aforementioned groove where the insert snaps into. The first reflector is the narrow beam reflector. This reflector has a parabolic bowl that, when coupled with either of the lenses of the present invention, projects a narrow beam of light, in the range of 10-15 degrees. Another reflector apparatus is the star shaped flood reflector apparatus. This reflector has a larger parabolic bowl that, when coupled with either of the lenses of the present invention, projects a flood beam of light, in the range greater or equal to 45 degrees. Both reflector apparatus can be connected through a post protruding downward vertically from the reflector which if needed connects to a mount.

Each implementation of the present invention includes insert options, each having the aforementioned ridge. One type of insert may have a uniform cylinder shape, with a closed top and a bottom. Inside the insert, the inner surface of the top can be any shape, but the most common embodiment mirrors the cylindrical shape of the outside. Another type of insert may contain a derby hat lens. This insert also is a cylinder, with a closed top and a bottom. This insert can contain a “ledge” along the outside bottom edge, which when the insert is snapped into the reflector apparatus, is flush with the reflector post, with the ridge of the insert firmly in place in the groove of the reflector apparatus. The insert or their tops may be colored, clear or frosted. The LEDs may be white or any spectrum of the wavelength used by LEDs.

In one application, the optic system comprises a narrow beam reflector with the groove and the ridge straight and multi-colored inserts with a white LED. In another application, the optic system may comprise a star flood beam reflector apparatus with the groove and the ridge slightly angled and frosted insert and an ultraviolet LED. In another application, the optic system may comprise parabolic reflector apparatus and a clear insert with an infrared LED. The combinations are numerous. The size of the optic system would depend on the need, one skilled in the art would know that a recreation vehicle would need a lot larger optic system than a medical device such as a phototherapy light.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explains how it differs from the plain and ordinary meaning Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above. Further, the inventors are fully informed of the standards and application of the special provisions of pre-AIA 35 U.S.C. §112, ¶6 and post-AIA 35 U.S.C. §112(f). Thus, the use of the words “function,” “means” or “step” in the Detailed Description or Description of the Drawings or claims is not intended to somehow indicate a desire to invoke the special provisions of pre-AIA 35 U.S.C. §112, ¶6 or post-AIA 35 U.S.C. §112(f), to define the invention. To the contrary, if the provisions of pre-AIA 35 U.S.C. §112, ¶6 or post-AIA 35 U.S.C. §112(f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of pre-AIA 35 U.S.C. §112, ¶6 or post-AIA 35 U.S.C. §112(f). Moreover, even if the provisions of pre-AIA 35 U.S.C. §112, ¶6 or post-AIA 35 U.S.C. §112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

The foregoing and other aspects, features, and advantages will be apparent to those artisans of ordinary skill in the art from the DETAILED DESCRIPTION and DRAWINGS.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an exploded view of an implementation of an optic system.

FIG. 2 depicts a top view of an implementation of a two-square narrow beam reflector.

FIG. 3 depicts a cross-sectional view of an implementation of an optic system with a reflector apparatus and a placing of the insert.

FIG. 4 depicts a top view of an implementation of a four-square star flood reflector apparatus.

FIG. 5 depicts prior art showing a reflector apparatus.

FIG. 6 depicts prior art showing a reflector apparatus, exploded view.

FIG. 7 depicts a cross-sectional view of an implementation of an insert of one shape, a flat top with a level ridge.

FIG. 8 depicts a cross-sectional view of an implementation of a derby hat insert.

FIG. 9 depicts a cross-sectional view of an implementation of a narrow beam reflector bowl.

FIG. 10 depicts a cross-sectional view of an implementation of a star flood reflector bowl.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

Conventional LEDS in optic systems are suitable for among other things such as vehicles, electronics, communications, and signaling found in the art generally use one of three assemblies: (1) a colored lens over a housing of white LEDs; (2) a clear lens over a housing of colored LEDs; or (3) a colored lens over a housing of colored LEDs. None offer bright light transmission in color on the order of white LEDs. None offer the ability to customize multi-wavelength lighting schemes because they are hampered by current internal and external LED lens designs and placements. Finally, optic systems using LEDs do not use optics with an insert that is attached to the reflector apparatus via a snapping mechanism that not only provides for simple and rapid change of LEDs within the optic system, but also allow for control of the LED degree of projection at a brighter level of transmission. The present invention addresses all of these shortcomings.

The present invention seeks to provide an optics system with a reflector apparatus that allows for a snap insert that contains an LED of any wavelength with a design that allows for brighter transmission and controlled projection. Specifically, some implementations of the present invention provide an insert with a colored lens that is integrated on the outside of the insert such that it fits closely over a white LED. These specially fabricated insert lens can be made in any color, including but not limited to, red, blue, green, yellow, amber, pink and purple. The LED that is placed inside can be of any wavelength. These specially fabricated insert lens can also not be limited to a color, they can be clear, white, or frosted with one or more LEDs inside of any wavelength.

The prior art uses integrated lenses in their optics that cover either two or four LEDs. By contrast, the integrated lenses of the present invention cover any quantity of LEDs. This individualization allows for maximum LED arrangement flexibility. The insert lenses of different or alternating colors can be adjacent to one another or arranged in rows, blocks of any size and even patterns, and the LEDs inside of the inserts can be arranged in rows, blocks of any size and even patterns of any wavelength. One skilled in the art recognizes that there is no maximum or minimum limit to the size of the reflector apparatus or to the size of the insert.

Finally, the applicants are unaware of any LED optics in which the insert snaps into the reflector apparatus from the bottom of the reflector apparatus and remains in place. All other integrated LED inserts attach to the reflector apparatus from the top.

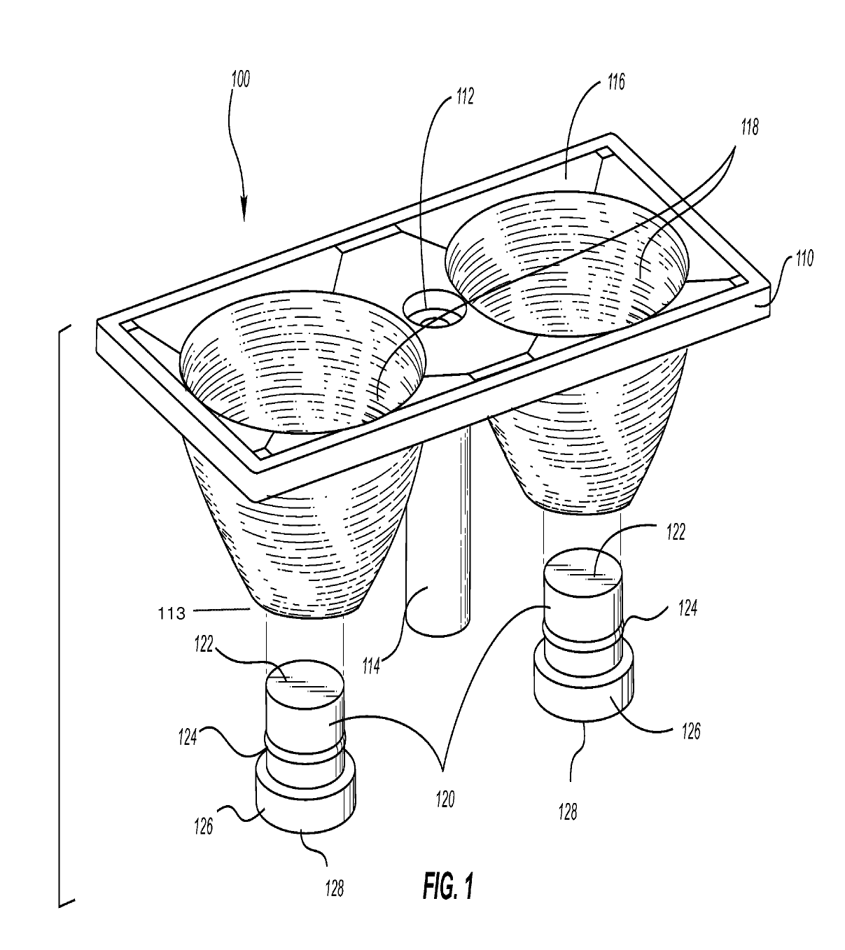

In one application of the invention, referring now to FIG. 1, a reflector apparatus 100 according to various aspects of the invention is depicted in an exploded view. In the embodiment shown in FIG. 1, the reflector apparatus 100 comprises a narrow beam reflector 110 and two inserts 120 and 125. The narrow beam reflector 110 has within its form a parabolic bowl 118 where the radius of the parabolic bowl is larger the farther away the reflector apparatus is from the of the insert 128 and the receiving groove 119 along the inside circumference of the base of the parabolic bowls. The inserts 120 and 125 each have a ridge 124 along the outside circumference of the cylinder body of the lens. This ridge 124 snaps into the receiving groove 119 of the rear 113 of the reflector apparatus 110. While FIG. 1 depicts an implementation having two inserts and parabolic bowls, some implementations may comprise a single insert and parabolic bowl or a plurality of inserts and parabolic bowls comprising any number of inserts and bowls that is appropriate for the desired luminosity and light output pattern. Some implementations may also comprise a single LED inside of the insert, while other implementations may also comprise a plurality of LEDs inside of the inserts.

Other features of the reflector apparatus 110 may include a faceted, sloped surface 116, a recessed hole 112 and a post 114 through which a connector may be placed for purposes of fastening the reflector apparatus 110 to any type of mount (not shown) after insertion of any type of insert in the rear 113. Other features of the insert 120 may include a closed top 122, a “brim” 126, which can be used but is not limited to being used for spacing and a bottom 128 where the LED is attached.

One insert lens 120 may be one color, and the insert lens 125 may be the same or a different color or may be clear or frosted. Insert lenses also can be clear, clear frosted or color frosted and can be different shapes, sizes and designs to achieve different effects and patterns. Indeed, either or both inserts 120 and 125 may also be clear and be hexagonal shaped with a blue LED inside. The possibilities are numerous. In one embodiment, the reflector apparatus 110 may be two-squared (shown), four-squared or any other desired configuration. The ridges 124 can be level or they can be angled. One skilled in the art would know what angle degree to make the ridges 124 so that the desired projection area is achieved.

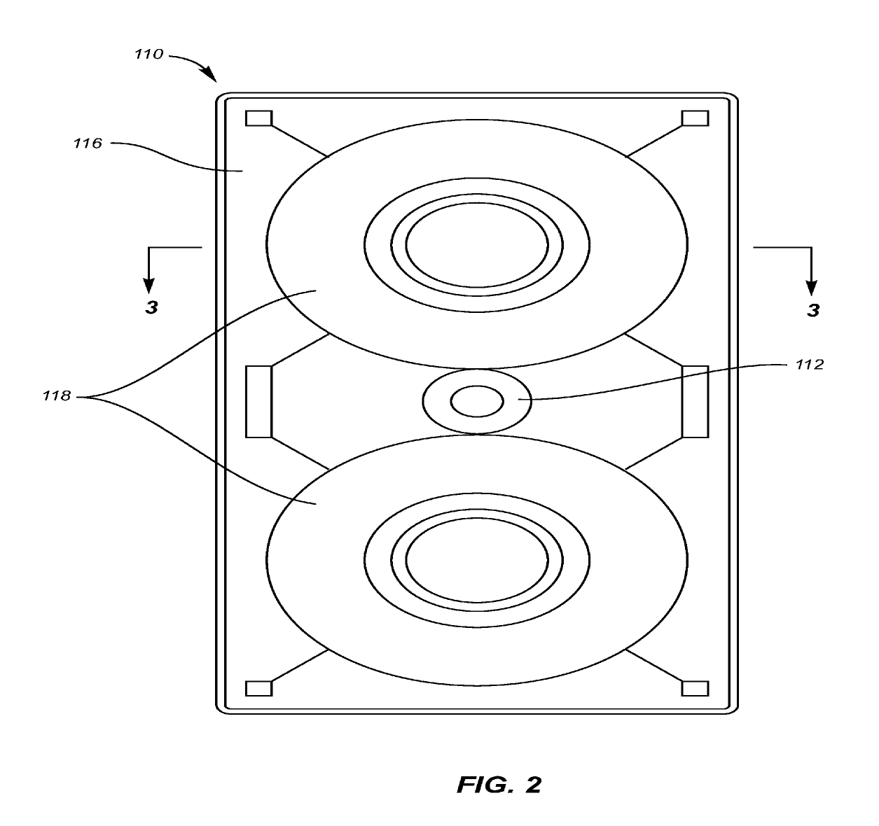

FIG. 2 depicts a top view of a two-square reflector apparatus 110. FIG. 2 shows the recessed hole 112 through which the connector holding the reflector apparatus to a mount passes, the faceted surface of the reflector apparatus 116, and the reflector bowls 118 where the inserts with the LEDs inside are placed. The reflector apparatus 110 can be two-squared or contain any amount of reflector bowls for insert reception. The reflector apparatus design can have the reflector bowls 118 straight across, diagonal, blocked, or any pattern desired.

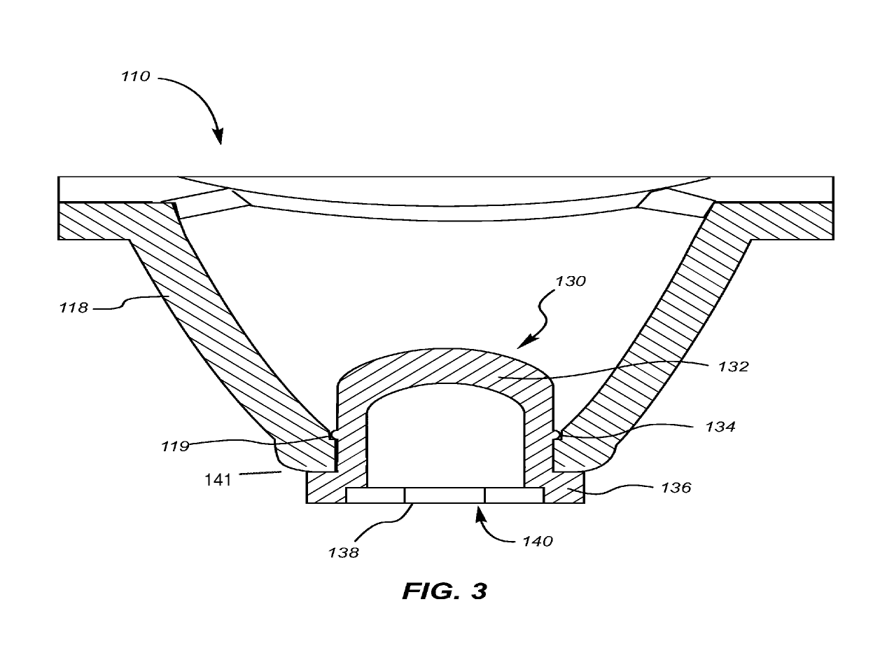

FIG. 3 depicts a cross-sectional view of a type of reflector apparatus 100 of an implementation of the present invention, with a narrow beam reflector bowl 110 and a derby hat insert lens 130. The reflector apparatus 110 is formed with a receiving groove 119 along the rear 141 inside surface of the parabolic bowl or below the parabolic bowl 118 near the reflector apparatus base or rear 141 in this implementation. Like the flat top insert lens, the derby insert lens 130 is formed to include a ridge 134 along the outside circumference of the lens, near the base. The insert ridge can be level across the outside of the insert, or it can be at any angle needed to achieve desired projection area. The insert ridge 134 can be at any height protruding out of the insert, in order to allow for desired project area and location of the LED transmittance. The insert ridge 134 and the reflector apparatus receiving groove 119 are depicted in the snapped in position. Other features of the insert may include derby hat insert lens 130 and may comprise a closed, hemispheric top 132, a brim 136 and a bottom 138.

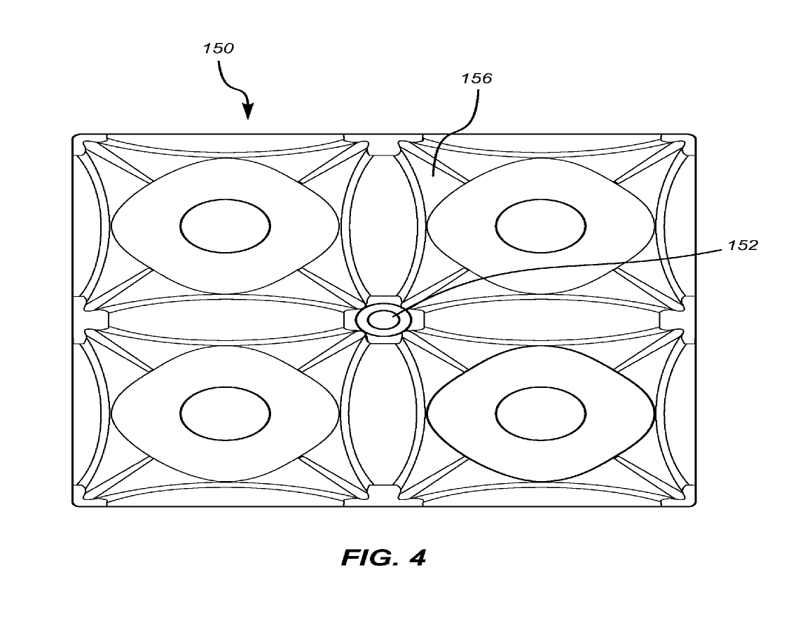

FIG. 4 is a top view of a four-squared star shaped flood reflector apparatus 150. Like the narrow beam reflector apparatus, the star shaped flood reflector apparatus 150 has a receiving groove (not shown) along the inside surface of the parabolic bowl or with any bowl shape used 158 near the reflector base. Also like the narrow beam reflector, the star shaped flood beam reflector 150 contains a recessed hole 152 and a post (not shown) through which a connector may be used to attach the reflector apparatus to a mount. One feature of the star shaped flood reflector apparatus 150 is the star design on the surface 156, which may provide aesthetic or functional advantages over non-patterned surfaces. However, as one skilled in the art would recognize after seeing this embodiment, the patterned surface of the reflector apparatus is not limited to star shaped or any specific pattern but any functional patterns can be embodied. Nor is the embodiment of the reflector apparatus limited to four-squared, the reflector apparatus can be block, diagonal, ten-squared, straight, round or of any design or pattern.

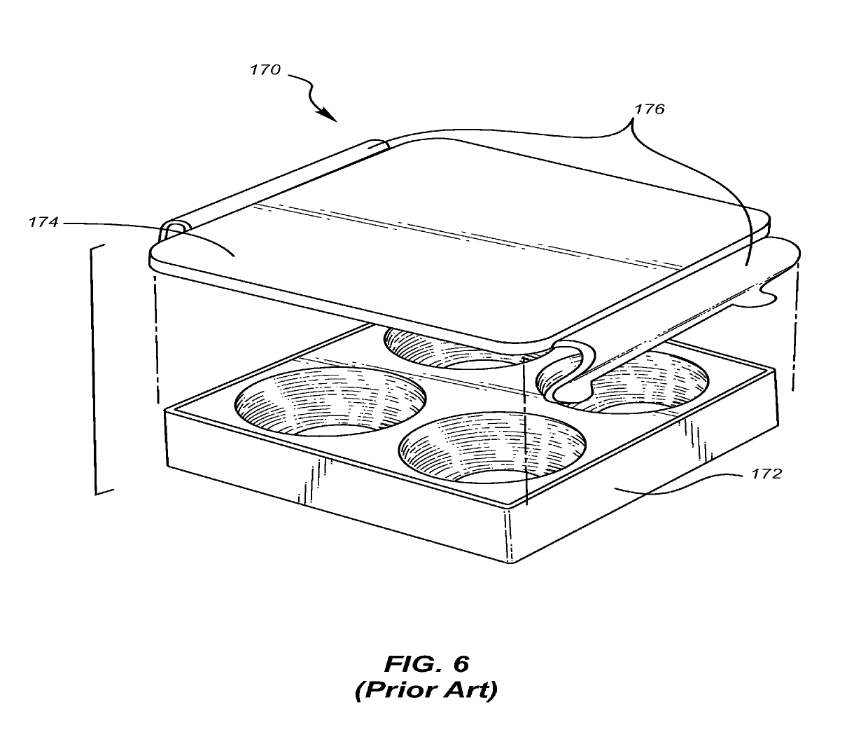

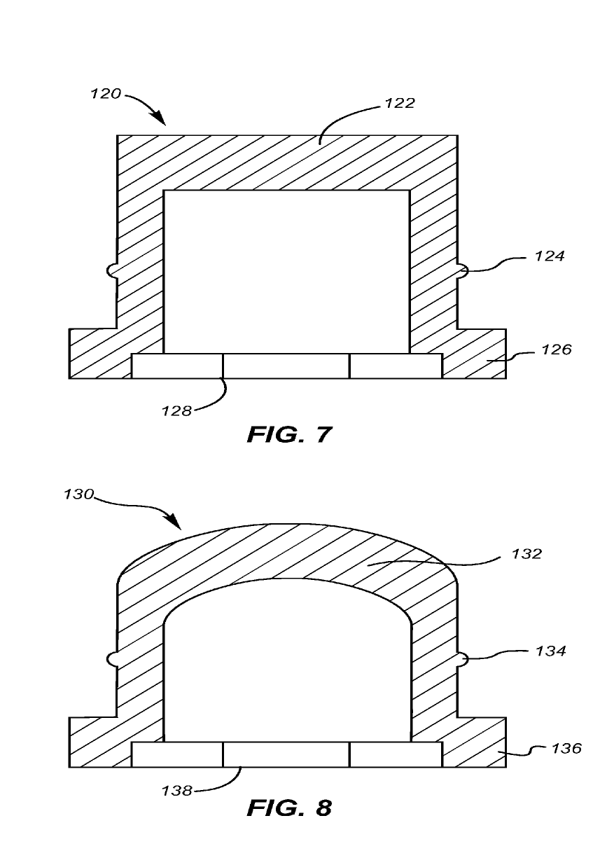

FIGS. 7 and 8 depict cross-sectional views of implementations of a flat top lens insert 120 and a derby hat lens insert 130, respectively. These views highlight only two of the many different shapes the lenses may take. The flat top lens insert 120 has a flat top outer surface 122 and is not limited to a flat top inner surface (as shown) or a hemispherical top inner surface. The derby hat lens insert 130 comprises a rounded/hemispherical top outer surface 132 and a hemispherical top inner surface that can follows/mirrors the shape of the outer surface (as shown). In each of FIGS. 7 and 8, the ridges employed for snapping the insert into the reflector apparatus are clearly shown as 124 in the top hat insert lens and 134 in the derby hat insert. In each of the FIGS. 7 and 8, the bottom 128 and 138 is shown, connected to the bottom 128 and 138 is among other things the LED.

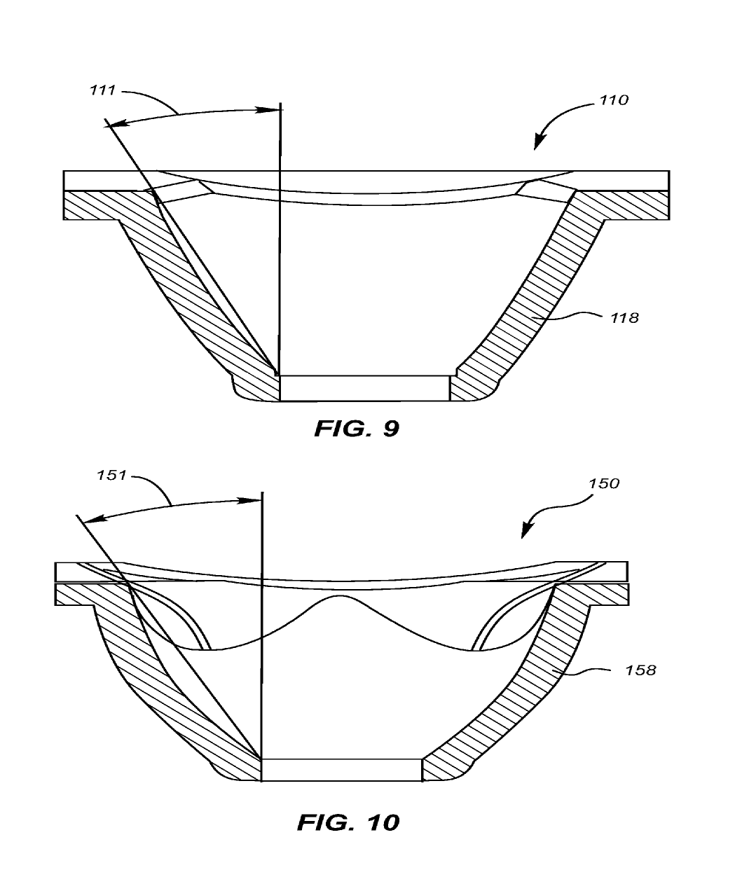

FIGS. 9 and 10 depict cross-sectional views of two of many implementations of a reflector apparatus. The first one is the narrow beam reflector apparatus 110 and the second, a star shaped flood beam reflector apparatus 150. These views highlight the many different parabolic shapes the reflector bowls may take. The narrow beam reflector 110 may have parabolic bowl 118 that is formed in a narrower shape in order to redirect LED rays into a spot beam in the range of approximately 10-15 degrees, which is represented by the projection line 111. The star shaped flood reflector apparatus 150 has a bowl 158 that is formed into a wider/broader shape in order to direct the light from the LED transmittance into a flood beam pattern in the range of approximately 45-60 degrees, which is represented by the projection line 151. One skilled in the art would recognize after seeing these embodiments that the shape of the reflector apparatus, the shape of the reflector apparatus bowl and the degree of slope of the insert ridge can each be used separately or in combination to direct the light projection, area and location.

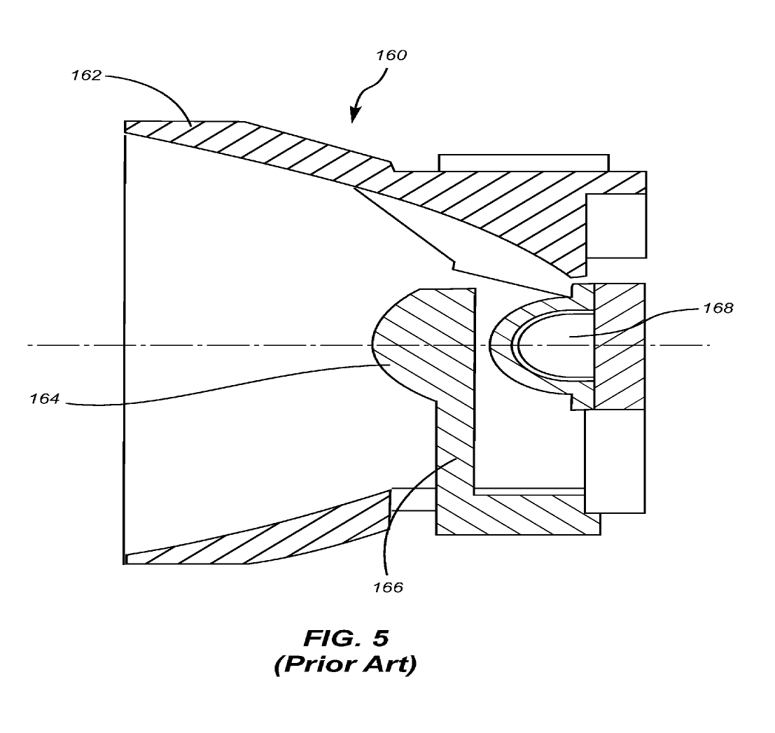

FIGS. 5 and 6 depict reflector-lens assembly prior art. In FIG. 5, the reflector-lens assembly 160 is comprised of a reflector 162, a lens 164 and the LED 168. The lens 164 is connected to the reflector 162 using a spider 166, which suspends the lens 164 over the LED 168. In FIG. 6, the reflector-lens assembly 170 is comprised of only a reflector 172 and a lens 174. The lens 174 is connected to the reflector via clips molded onto the sides of the lens 174. FIG. 6 is an example of an assembly wherein the lens if colored would cover multiple LEDs at once, preventing a multi-color display.

In places where the above description refers to particular implementations of systems and methods for reflector-lens assemblies, it should be readily apparent that a number of modifications may be made without departing from the spirit thereof and that these implementations may be supplied to other embodiments to reflector-lens assemblies.

We claim:

1. An optics system comprising:
a polymeric material receptacle apparatus comprising a receptacle bowl; and
a removable insert located at a rear of the receptacle apparatus, the removable insert configured to be deterred from movement by contact between an insert body and the rear of the receptacle apparatus and the receptacle apparatus comprises a top surface and the rear of the receptacle apparatus comprises an inside groove and the insert comprises an outer ridge configured to snap into the groove at the rear of the receptacle apparatus.

2. The optics system of claim 1, wherein the receptacle apparatus comprises a post.

3. The optics system of claim 1, wherein the outer ridge of the insert comprises a slope from 0 to 65 degrees.

4. The optics system of claim 1, wherein the outer ridge extends outward from the insert.

5. The optics system of claim 1, wherein the receptacle bowl comprises a parabolic shape having a radius that increases in distance from rear to front.

6. An optics system comprising:
a plurality of polymeric material receptacle apparatus comprising receptacle bowls; and
a plurality of removable inserts located at a rear of the receptacle apparatus, the removable inserts configured to be deterred from movement by contact between an insert body and the rear of the receptacle apparatus and the receptacle apparatus comprises a top surface and the rear of the receptacle apparatus comprises an inside groove and the insert comprises an outer ridge configured to snap into the groove at the rear of the receptacle apparatus, wherein each insert contains an LED.

7. The optics system of claim 6 wherein the plurality of receptacle apparatus is arranged in a circle, a star shaped, or a square pattern.

8. The optics system of claim 6 wherein the receptacle apparatus comprise a top surface that is clear, frosted, or colored.

9. The optics system of claim 6 further comprising a post configured to couple the receptacles to a mount.

10. The optics system of claim 6 comprising a reflective polymeric material and coating.

11. The optics system of claim 6 wherein the receptacle bowl comprises a parabolic shape with a radius increasing from rear to front.

12. An optics system comprising:
a glass or glass composite receptacle apparatus comprising receptacle bowls; and
a plurality of removable inserts located at a rear of the receptacle apparatus, the removable inserts configured to be deterred from movement by contact between an insert body and the rear of the receptacle apparatus and the receptacle apparatus comprises a top surface and the rear of the receptacle apparatus comprises an inside groove and the insert comprises an outer ridge configured to snap into the groove at the rear of the receptacle apparatus, wherein each insert contains one or multiple LEDs and the inserts, receptacle bowls and receptacle apparatus are all adjustable.

13. The optics system of claim 12 contains an insert lens where each lens is clear, frosted or colored.

14. The optics system of claim 12 wherein each LED emits a wavelength of light.

15. The optics system of claim 12 wherein the outer ridge of the insert contains a slope from 0 to 65 degrees.

16. The optics system of claim 12 wherein the inserts are adjustable by changing the insert ridge.

17. The optics system of claim 12 where each insert is shaped both inside and out, and the inside shape is uncorrelated to the outside shape.

18. The optics system of claim 12 wherein the insert LED light's projection is be controlled by adjusting the design of the receptacle bowl.

19. The optics system of claim 12 where each insert contains zero to one brims.

20. The optics system of claim 12 where each insert contains a bottom that is attached both to the LED and the insert.
